(19) United States
(12) Patent Application Publication
(10) Pub. No.: US 2007/0198855 A1
(43) Pub. Date: Aug. 23, 2007

(54) Information Recording Media, Information Recording Device And Method, Information Distribution Device And Method, And Computer Program

(75) Inventors: Kazuo Kuroda, Saitama (JP); Eiji Muramatsu, Saitama (JP); Ryuichiro Yoshimura, Saitama (JP); Andy Parsons, Long Beach, CA (US); Ken Tatsumi, Long Beach, CA (US)

Correspondence Address: YOUNG & THOMPSON, 745 SOUTH 23RD STREET, 2ND FLOOR, ARLINGTON, VA, 22202, US

(73) Assignee: PIONEER CORPORATION, TOKOROZAWA WORKS, Saitama (JP)

(21) Appl. No.: 11/628,500

(22) PCT Filed: Jun. 7, 2004
(86) PCT No.: PCT/JP05/10433

§ 371 Date: Jan. 5, 2007

(30) Foreign Application Priority Data
Jun. 7, 2004 (JP) 2004 168892

(51) Int. Cl. G06F 12/14

(52) U.S. Cl. 713/189

(57) ABSTRACT

An information recording apparatus (300) transmits identification information (Media ID) of an information recording medium (100) to an information distributing apparatus (200). The information distributing apparatus obtains an encryption key (disk key) from the identification information which is sent from the information recording apparatus, and encrypts record information (content). The information distribution apparatus distributes the encrypted record information (encrypted content). The information recording apparatus records the distributed encrypted record information into the information recording medium.

### TECHNICAL FIELD

The present invention relates to an information recording medium, such as a DVD, an information recording apparatus and an information recording method, such as a DVD recorder, an information distributing apparatus for and an information distributing method of distributing content to the information recording apparatus or the like, and a computer program which makes a computer function as the information recording apparatus and the information distributing apparatus or the like, for example.

### BACKGROUND ART

A large-volume recording medium, such as a DVD, has been spread, and even at home, an environment in which movie content or the like can be readily watched through a network is being completed. Moreover, such a style has been also spread that the movie content or the like is obtained through the network and that the obtained movie content is recorded onto the DVD or the like and watched.

In this case, in order to protect the copyright of the movie content, the distributed movie content or the like is generally encrypted. This encryption is performed in accordance with an encryption system described in a non-patent document 1, for example. As a more specific method of distributing the movie content or the like, as described in a patent document 1 or the like, for example, there is suggested a distribution system for recording an encryption key used for an encryption process in advance on a record-type DVD or the like, such as a DVD-R/RW, selling it, and distributing the encrypted movie content through the network.

In addition, there are also suggested various encryption methods (or content distribution system), as described in patent documents 2 and 3. The encryption methods prevent the illegal copy of the movie content or the like in the middle of the distribution, and at the same time, the methods also lead to the protection of the copyright of the movie content.

Patent document 1: Japanese Patent Application Laid Open NO. 2001-307427

Patent document 2: Japanese Patent Application Laid Open NO. 2001-357001

Patent document 3: Japanese Patent Application Laid Open NO. 2000-331412

Non-patent document 1: “Protection of DVD content”, Toshiba review, Vol. 58, No. 6, p 28-p 31, 2003

### DISCLOSURE OF INVENTION

### SUBJECT TO BE SOLVED BY THE INVENTION

In the above-mentioned various encryption methods, however, it is necessary to transmit the encryption key recorded on the record-type DVD or the like, to the distribution side of the movie content. Thus, there is also a possibility that the encryption key is illegally obtained in the network. Such a situation is not preferable at all from the viewpoint of protecting the copyright of the movie content or the like, and a more highly confidential distribution system is desired.

It is therefore an object of the present invention to provide an information recording medium, an information recording apparatus, an information recording method, an information distributing apparatus, and an information distributing method, which can distribute the content or the like while maintaining high confidentiality, and a computer program which makes a computer function as the information recording apparatus and the information distributing apparatus.

### MEANS FOR SOLVING THE SUBJECT

(Information Recording Medium)

The above object of the present invention can be achieved by an information recording medium provided with: an identification information recording area in which identification information for identifying an information recording medium is recorded in advance; an encryption key recording area in which an encryption key for encrypting record information is recorded in advance, the encryption key corresponding to the identification information; and an encrypted record information recording area to record therein encrypted record information which is encrypted on the basis of the encryption key.

According to the information recording medium of the present invention, it is possible to preferably record the encrypted record information (e.g. encrypted content, described later) which is encrypted and distributed or the like, into the encrypted record information recording area. Moreover, as described later, by transmitting the identification information which is recorded into the identification information recording area, from the information recording apparatus to the information distributing apparatus, it is possible to distribute the record information (content), or the like, while maintaining high confidentiality.

Incidentally, in the present invention, the encryption key is used for the encryption of the record information; however, the encryption by using the -encryption key may be the encryption of the record information directly using the encryption key, or it may be the encryption of the record information indirectly using the encryption key (e.g. such construction that the encryption of the record information is performed by using another key, and that the key, which is used for the encryption of the record information, is encrypted by using the encryption key recorded in the encryption key recording area). In short, a key contributing to the encryption of the record information somehow corresponds to the “encryption key” of the present invention.

In one aspect of the information recording medium of the present invention, the identification information is information peculiar to the information recording medium.

According to this aspect, it is possible to properly and certainly recognize the encryption key recorded on the information recording medium, from the identification information.

(Information Recording Apparatus)

The above object of the present invention can be also achieved by an information recording apparatus for recording the encrypted record information onto the above-mentioned information recording medium of the present invention (including its various aspects), the information recording apparatus provided with: an identification information transmitting device for transmitting the identification information which is recorded on the information recording medium, to an information distributing apparatus for distributing the encrypted record information; an encrypted record information receiving device for receiving the encrypted record information, which is distributed from the information distributing apparatus and is encrypted on the basis of the encryption key corresponding to the identification information; and a recording device for recording the received encrypted record information.

According to the information recording apparatus of the present invention, by the operation of the recording device, it is possible to record the encrypted record information distributed from the information distributing apparatus (e.g. the information distributing apparatus of the present invention described later), into the encrypted record information recording area.

Particularly in the present invention, in order to encrypt the record information, the identification information recorded on the information recording medium is transmitted to the information distributing apparatus, by the operation of the identification information transmitting device. Namely, it is not the encryption key recorded in advance on the information recording medium that is directly transmitted, but the identification information which can specify the encryption key and which itself is open information (i.e. which does not require high confidentiality) that is transmitted. Then, on the information distributing apparatus side, as described later, the encryption key is obtained on the basis of the transmitted identification information, to thereby encrypt the record information. Then, the record information which is encrypted (i.e. the encrypted record information) is distributed by the information distributing apparatus to the information recording apparatus, and recorded onto the information recording medium.

At this time, even if the transmitted identification information is browsed by a malicious third party (or a third party having no authority), the identification information itself is originally open information, so that the encryption method (e.g. the encryption key, etc.) is not recognized by using this. Therefore, even if the encrypted record information is browsed by the malicious third party at the distribution stage, the third party cannot decode the encrypted record information. If not the identification information but the encryption key, which itself indicates the encryption method (i.e. which requires high confidentiality), is directly transmitted from the information recording apparatus to the information distributing apparatus, there is a possibility that the malicious third party obtains the encryption key. As a result, there is also considered such a disadvantage that the illegally obtained encrypted record information is decoded. However, in the present invention, the identification information, which itself is open information, is transmitted as described above, such a disadvantage can be preferably prevented. Therefore, there is such a great advantage that it is possible to greatly improve (or increase) the confidentiality in the distribution of the record information, such as content. In other words, it is possible to distribute the record information under a secure environment.

Consequently, according to the information recording apparatus of the present invention, it is possible to improve the confidentiality in the distribution or the like of the content, and thus it is possible to preferably protect the copyright of the content.

Incidentally, in response to the various aspects owned by the above-mentioned information recording medium of the present invention, the information recording apparatus of the present invention can also adopt various aspects.

In one aspect of the information recording apparatus of the present invention, the identification information transmitting device encrypts the identification information and transmits it to the information distributing apparatus.

According to this aspect, it is possible to prevent the identification information from being browsed by the malicious third party, and thus it is possible to further increase the confidentiality of the information which is mutually exchanged between the information recording apparatus and the information distributing apparatus.

In another aspect of the information recording apparatus of the present invention, if the recording of the encrypted record information is not succeeded, the recording device makes the encrypted record information unusable.

According to this aspect, for example, if only one portion of the encrypted record information is recorded onto the information recording medium or in similar cases, it is possible to make the one portion of the encrypted record information in the unusable condition. Thus, if the distribution of the encrypted record information is not certainly completed, the encrypted record information cannot be used (i.e. not reproduced nor watched), so that it is possible to prevent the disadvantage that the encrypted record information is illegally used. Therefore, it is possible to increase the confidentiality in the content distribution.

Incidentally, as the case where the recording is not succeeded, there are listed a case where the distribution or reception of the encrypted record information is not normally performed, a case where the recording of the encrypted record information is completely only partially, and the like.

In an aspect of the information recording apparatus in which the encrypted record information is made unusable, as described above, the encrypted record information may be made unusable by not recording a file system or not recording an accurate file system.

By virtue of such construction, by not recording the file system information normally necessary for the reproduction of the record information, it is possible to relatively easily make the encrypted record information in which the recording is not succeeded, unusable. Alternatively, by not recording the legal (proper) file system which complies with the standard (or by recording the illegal file system which dose not comply with the standard), it is possible to relatively easily make the encrypted record information in which the recording is not succeeded, unusable. In short, if the proper file system necessary for the reproduction operation is not recorded together with the encrypted record information, it is possible to relatively easily make the encrypted record information unusable.

In an aspect of the information recording apparatus in which the encrypted record information is made unusable, as described above, the encrypted record information may be made unusable by overwriting in a recording area portion in which the encrypted record information is recorded.

By virtue of such construction, it is possible to relatively easily make the encrypted record information unusable, and as described above, it is possible to further increase the confidentiality in the content distribution.

In another aspect of the information recording apparatus of the present invention, the information recording apparatus is further provided with a result information transmitting device for transmitting result information indicating whether or not the recording of the encrypted record information is succeeded, to the information distributing apparatus.

According to this aspect, even on the information distributing apparatus side, it is possible to judge whether or not the recording of the encrypted information is normally performed. Therefore; if the recording of the encrypted information is not normally performed, it is possible to distribute the encrypted record information again, for example, and it is possible to realize the stable or certain content distribution.

(Information Recording Method)

The above object of the present invention can be also achieved by an information recording method of recording the encrypted record information onto the above-mentioned information recording medium of the present invention (including its various aspects), the information recording method provided with: an identification information transmitting process of transmitting the identification information which is recorded on the information recording medium, to an information distributing apparatus for distributing the encrypted record information; an encrypted record information receiving process of receiving the encrypted record information, which is distributed from the information distributing apparatus and is encrypted on the basis of the encryption key corresponding to the identification information; and a recording process of recording the received encrypted record information.

According to the information recording method of the present invention, it is possible to receive the various benefits owned by the above-mentioned information recording apparatus of the present invention.

Incidentally, in response to the various aspects owned by the above-mentioned information recording apparatus of the present invention, the information recording method of the present invention can also adopt various aspects.

(Information Distributing Apparatus)

The above object of the present invention can be also achieved by an lo information distributing apparatus for distributing the encrypted record information to the above-mentioned information recording apparatus of the present invention (including its various aspects), the information distributing apparatus provided with: an identification information receiving device for receiving the identification information which is transmitted from the information recording apparatus; an encryption key obtaining device for obtaining the encryption key corresponding to the received identification information; an encrypting device for encrypting the record information on the basis of the obtained encryption key, to thereby generate the encrypted record information; and a distributing device for distributing the generated encrypted record information to the information recording apparatus.

According to the information distributing apparatus of the present invention, the encryption key is obtained by using the identification information transmitted by the information recording apparatus, and the encrypted record information, encrypted by using the encryption key, is distributed to the information recording apparatus. Namely, without exchanging the encryption key itself which requires high confidentiality, by exchanging the identification information which does not require high confidentiality that much (so to speak, open), it is possible to encrypt and distribute the record information, or the like. Therefore, as in the above-mentioned information recording apparatus of the present invention, there is such a great advantage that it is possible to greatly improve (or increase) the confidentiality in the distribution of the record information, such as the content.

Consequently, according to the information distributing apparatus of the present invention, it is possible to receive the same various benefits as those owned by the above-mentioned information recording apparatus of the present invention.

Incidentally, in response to the various aspects owned by the above-mentioned information recording medium or information recording apparatus of the present invention, the information distributing apparatus of the present invention can also adopt various aspects.

In one aspect of the information distributing apparatus of the present invention, the encryption key and the identification information are associated in a relationship of N versus M (wherein each of N and M is an integer of 1 or more).

According to this aspect, it is possible to randomly associate the identification information and the encryption key, to thereby further increase the confidentiality in the distribution of the record information.

In another aspect of the information distributing apparatus of the present invention, the encryption key obtaining device obtains the encryption key on the basis of at least one of a correspondence table and a function for defining an association between the identification information and the encryption key.

According to this aspect, it is possible to relatively easily obtain the encryption key corresponding to the identification information, with reference to the correspondence table and the function or the like.

In another aspect of the information distributing apparatus of the present invention, an attribute of the distributed encrypted record information is a “Never Copy” attribute.

According to this aspect, it is impossible to copy or duplicate, or reproduce the distributed encrypted information, until it is certainly recorded onto the preferable recording medium. Therefore, it is possible to further increase the confidentiality in the distribution of the record information.

In another aspect of the information distributing apparatus of the present invention, the encrypting device encrypts the record information by using a predetermined title key and encrypts the title key by using the encryption key, to thereby generate the encrypted record information.

According to this aspect, as in the encryption system described in the non-patent document 1 described above, for example, it is possible to generate the encrypted record information, which includes the record information encrypted by using the title key and the title key encrypted by using the encryption key. Namely, the record information is severely encrypted by using both the title key and the encryption key, so that it is possible to further increase the confidentiality in the distribution of the record information, and thus it is possible to preferably protect the copyright of the content.

(Information Distributing Method)

The above object of the present invention can be also achieved by an information distributing method of distributing the encrypted record information to the above-mentioned information recording apparatus of the present invention (including its various aspects), the information distributing method provided with: an identification information receiving process of receiving the identification information which is transmitted from the information recording apparatus; an encryption key obtaining process of obtaining the encryption key corresponding to the received identification information; an encrypting process of encrypting the record information on the basis of the obtained encryption key, to thereby generate the encrypted record information; and a distributing process of distributing the generated encrypted record information to the information recording apparatus.

According to the information distributing method of the present invention, it is possible to receive the various benefits owned by the above-mentioned information distributing apparatus of the present invention.

Incidentally, in response to the various aspects owned by the above-mentioned information distributing apparatus of the present invention, the information distributing method of the present invention can also adopt various aspects.

(Computer Program)

The above object of the present invention can be also achieved by a first computer program for recording control to control a computer provided in the above-mentioned information recording apparatus of the present invention (including its various aspects), to make the computer function as at least one portion of the identification information transmitting device, the encrypted record information receiving device, and the recording device.

The above object of the present invention can be also achieved by a second computer program for distribution control to control a computer provided in the above-mentioned information distributing apparatus according of the present invention (including its various aspects), to make the computer function as at least one portion of the identification information receiving device, the encryption key obtaining device, the encrypting device, and the distributing device.

According to the first or second computer program of the present invention, the above-mentioned information recording apparatus or information distributing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned information recording apparatus or information distributing apparatus of the present invention, the first or second computer program of the present invention can also adopt various aspects.

The above object of the present invention can be also achieved by a first computer program product in a computer-readable medium for tangibly embodying a program of instructions executable by a computer provided in the above-mentioned information recording apparatus of the present invention (including its various aspects), to make the computer function as at least one portion of the identification information transmitting device, the encrypted record information receiving device, and the recording device.

The above object of the present invention can be also achieved by a second computer program product in a computer-readable medium for tangibly embodying a program of instructions executable by a computer provided in the above-mentioned information distributing apparatus of the present invention (including its various aspects), to make the computer function as at least one portion of the identification information receiving device, the encryption key obtaining device, the encrypting device, and the distributing device.

According to the first or second computer program product of the present invention, the above-mentioned information recording apparatus or information distributing apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned information recording apparatus or information distributing apparatus of the present invention.

These effects and other advantages of the present invention will become more apparent from the following embodiments.

As explained above, the information recording medium of the present invention is provided with: the identification information recording area; the encryption key recording area; and the encrypted record information recording area. Moreover, the information recording apparatus of the present invention is provided with: the identification information transmitting device; the encrypted record information receiving device; and the recording device. The information recording method of the present invention is provided with: the identification information transmitting process; the encrypted record information receiving process; and the recording process. Moreover, the information distributing apparatus of the present invention is provided with: the identification information receiving device; the encryption key obtaining device; the encrypting device; and the distributing device. The information distributing method of the present invention is provided with: the identification information receiving process; the encryption key obtaining process; the encrypting process; and the distributing process. Therefore, it is possible to distribute the content, or the like, while maintaining high confidentiality.

### BRIEF DESCRIPTION OF DRAWINGS

FIG. 1 is a plan view conceptually showing the basic structure of an optical disc in an embodiment of the information recording medium of the present invention.

FIG. 2 is a block diagram conceptually showing the entire structure of a content distribution system using respective embodiments of the information recording/reproducing apparatus and the information distributing apparatus of the present invention, and the basic structure of the information distributing apparatus in the embodiment.

FIG. 3 is a plan view conceptually showing the basic structure of the information recording/reproducing apparatus in the embodiment.

FIG. 4 is a flowchart conceptually showing a flow of respective operations of the information recording/reproducing apparatus and the 120, there is recorded a disk key (one specific example of the “encryption key” of the present invention) used for the encryption of content (content data). The disk key is recorded by embossed pits or a record mark, formed in advance, for example; Moreover, the disk key can be arbitrarily set by a right holder of the copyright of the content which is recorded onto the optical disc 100 and a manufacturer of the optical disc 100 or the like.

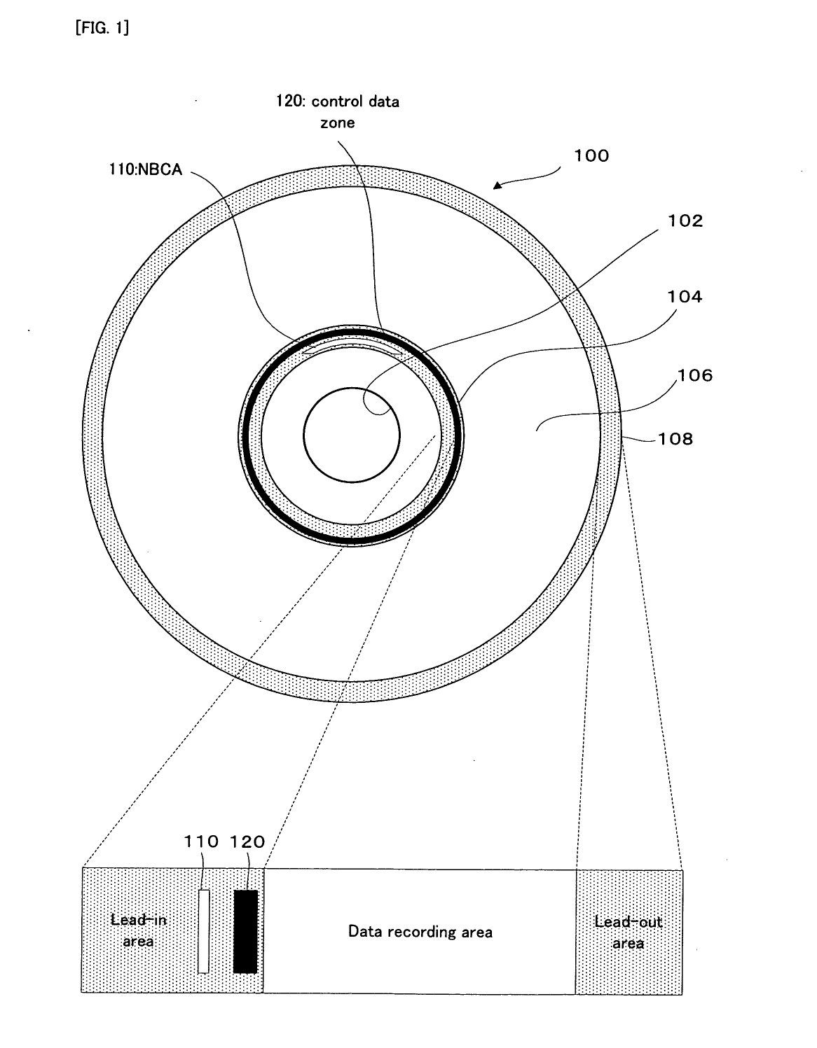

Incidentally, the disk key is recorded in the control data zone 120, with the disk key encrypted by a master key provided for an information recording/reproducing apparatus described later. The master key is a key individually allocated to the manufacturer of the information recording/reproducing apparatus or the like. At this time, it is not sure which information recording/reproducing apparatus (specifically, which information recording/reproducing apparatus made by which manufacturer) records or reproduces the content on the optical disc 100. Thus, a plurality of disk keys (disk key set) encrypted by all of the master key, which can be allocated to the manufacturer or the like, are preferably recorded in the control data zone 120.

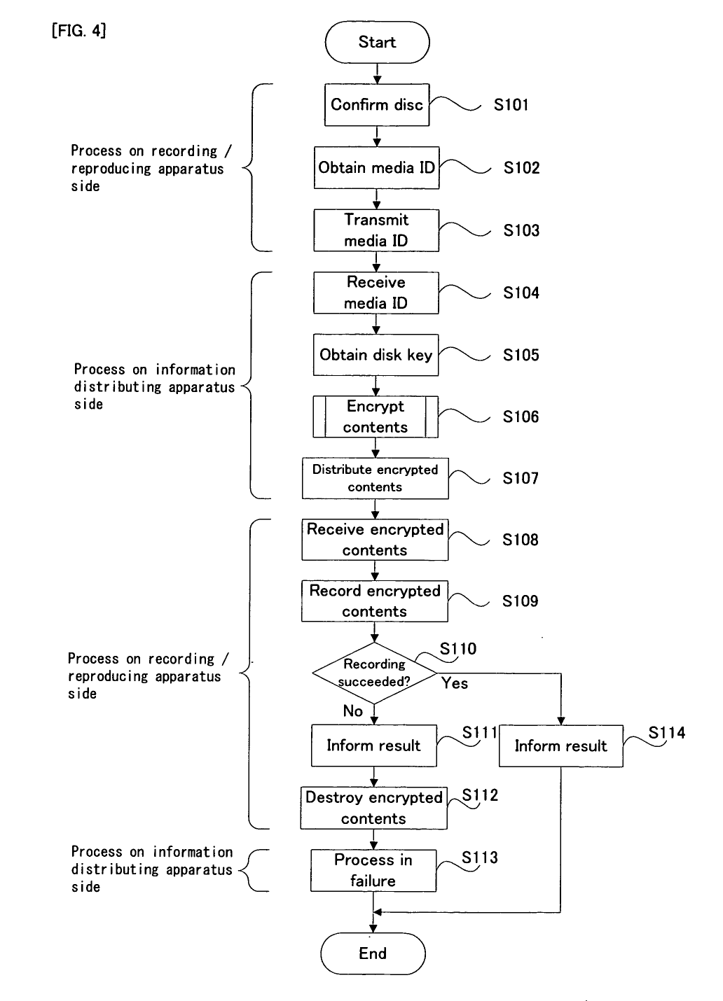

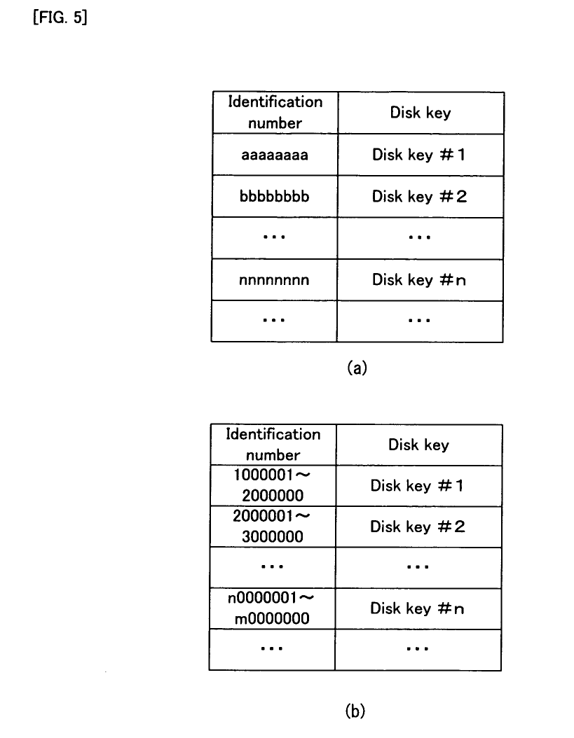

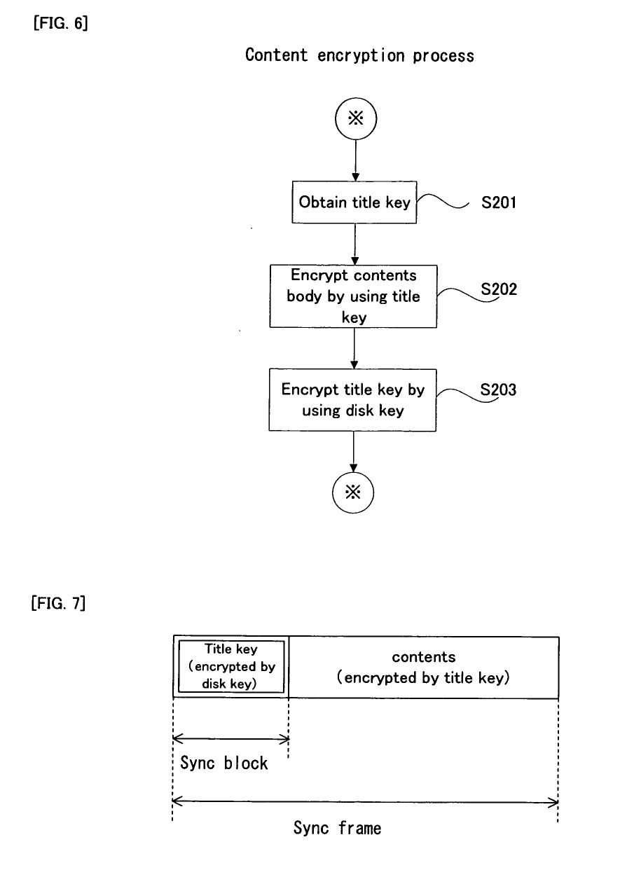

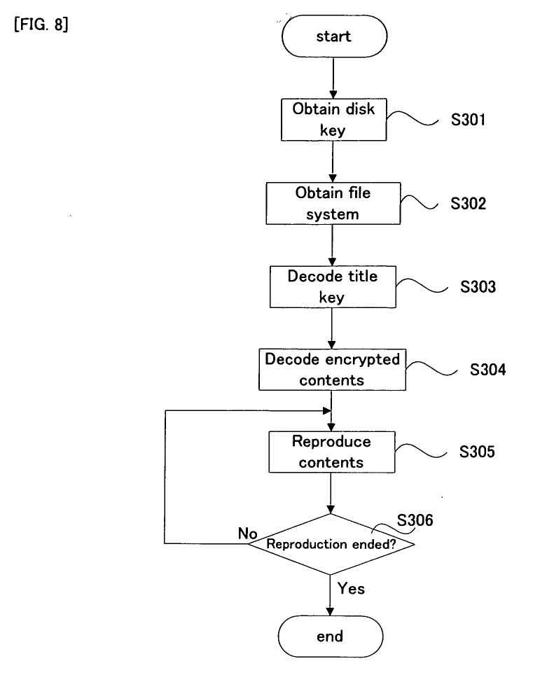

Then, in the embodiment, the media ID recorded in the NBCA 110 is transmitted to an information distributing apparatus, and the content is encrypted by using the disk key corresponding to the transmitted media ID. Moreover, the encrypted content is distributed to the information recording/reproducing apparatus, and recorded into the data recording area 106. Moreover, the information recording/reproducing apparatus decodes the encrypted content on the basis of the disk key recorded in the control data zone 120, and reproduces the content. These various operations will be explained in detail later (refer to FIG. 4, etc.).

(Information Recording Apparatus and Information Distributing Apparatus)

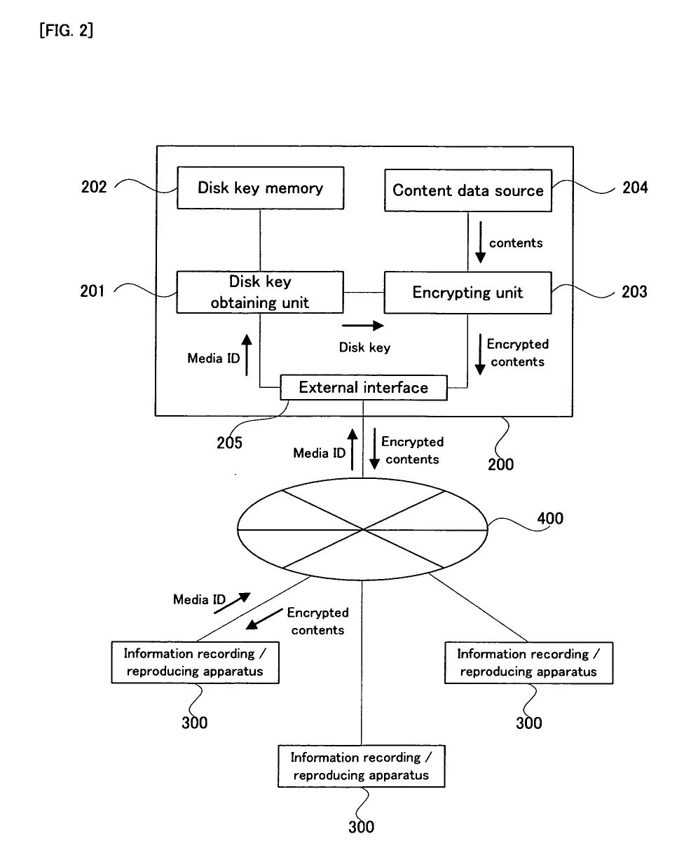

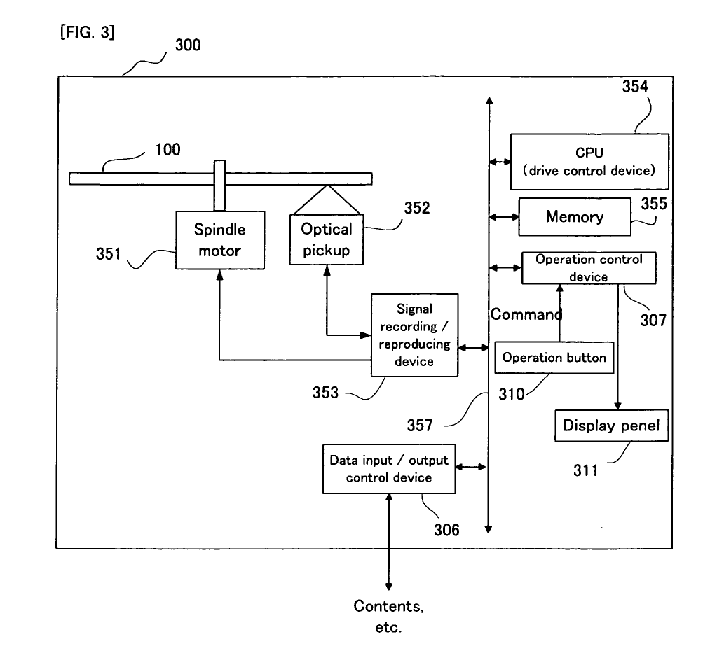

Next, with reference to FIG. 2 to FIG. 8, the embodiments of the information recording apparatus and the information distributing apparatus of the present invention will be explained. Incidentally, in the explanation below, the information recording/reproducing apparatus capable of not only recording the content but also reproducing the content will be explained, as one specific example of the information recording apparatus of the present invention.

(1) Basic Structure

Firstly, with reference to FIG. 2 and FIG. 3, an explanation will be given for the basic structure of the information recording/reproducing apparatus and the information distributing apparatus in the embodiment. FIG. 2 is a block diagram conceptually showing the entire structure of a content distribution system using respective embodiments of the information recording/reproducing apparatus and the information distributing apparatus of the present invention, and the basic structure of the information distributing apparatus in the embodiment. FIG. 3 is a plan view conceptually showing the basic structure of the information recording/reproducing apparatus in the embodiment.

As shown in FIG. 2, an information distributing apparatus 200 and an information recording/reproducing apparatus 300 are connected through a network 400, to thereby form a content distribution system.

As shown in FIG. 2, the information distributing apparatus 200 is provided with: a disk key obtaining unit 201, which is one specific example of the “encryption key obtaining device” of the present invention; a disk key memory 202; an encrypting unit 203, which is one specific example of the “encrypting device” of the present invention; a content data source 204; and an external interface 205, which is one specific example of the “identification information receiving device” and the “distributing device” of the present invention.

The disk key obtaining unit 201 is constructed to obtain a desired disk key, on the basis of both the media ID obtained through the external interface 205 and a disk key table stored in the disk key memory 202. For example, the disk key may be generated on the basis of the disk key table stored in the disk key memory 202. Alternatively, if the disk key itself is stored in advance in the disk key memory 202 in addition to the disk key table, one disk key corresponding to the obtained media ID may be obtained from the disk key memory 202.

The disk key memory 202 stores therein the disk key tale or the like indicating an association between the media ID and the disk key. Moreover, the disk key memory 202 may be constructed to store the disk key itself.

The encrypting unit 203 encrypts various content outputted from the content data source 204, by using the disk key obtained on the disk key obtaining unit 201. As a result, the content which is encrypted (hereinafter referred to as “encrypted content”, as occasion demands) is generated. This encryption process will be described in detail later (refer to FIG. 6 and FIG. 7).

The content data source 204 stores the various content (e.g. video content, such as a movie and a TV program, and music content, etc.) which is recorded onto the optical disc 100. Then, the content data source 204 is constructed to output the stored various content to the encrypting unit 203. Alternatively, it may be constructed to receive, for example, a program which is broadcasted through the network or through a ground wave and a satellite wave, and to output the received program (i.e. the various content) to the encrypting unit 203.

The external interface 205 is constructed to output (or transmit) the data from the information distributing apparatus 200 to the exterior, or to obtain (or receive) the data inputted (or transmitted) from the exterior. For example, it is constructed to receive the media ID transmitted from the information recording/apparatus 300 and to transmit (distribute) the encrypted content to the information recording/apparatus 300.

Moreover, the operation of the information distributing apparatus 200 is controlled by a not-illustrated CPU or the like. Namely, the above-mentioned constitutional elements perform the above-mentioned respective various operations, under the control of the CPU.

As shown in FIG. 3, the information recording/reproducing apparatus 300 is provided with: a spindle motor 351; an optical pickup 352; a signal recording/reproducing device 353, which is one specific example of the “recording device” of the present invention; a CPU (drive control device) 354; a memory 355; a data input/output control device 306, which is one specific example of the “identification information transmitting device” and the encrypted record information receiving device” of the present invention; an operation button 310; a display panel 311; and a bus 357.

The spindle motor 351 is intended to rotate and stop the optical disc 100, and operates upon accessing the optical disc. More specifically, the spindle motor 351 is constructed to rotate and stop the optical disc 100 at a predetermined speed, under spindle servo from a not-illustrated servo unit or the like.

The optical pickup 352 is intended to perform the recording/reproduction with respect to the optical disc 100, and is provided with a laser device, a lens, and the like. More specifically, the optical pickup 352 irradiates the optical disc 100 with a light beam, such as a laser beam, as reading light with a first power upon reproduction, and as writing light with a second power upon recording, with it modulated.

The signal recording/reproducing device 353 controls the spindle motor 351 and the optical pickup 352, to record and reproduce the content with respect to the optical disc 100.

The memory 355 is used in the general data processing on the information recording/reproducing apparatus 300, including a buffer area for the recording/reproduction data, an area used as an intermediate buffer when the data is converted into the data that can be used on the signal recording/reproducing device 353, and the like. Moreover, the memory 355 is provided with: a ROM area into which a program for performing an operation as the information recording/reproducing apparatus 300 is stored; a buffer used for compression/decompress/decoding) of data; a RAM area into which a parameter required for the operation of the program or the like is stored; and the like.

The CPU (drive control device) 354 is connected to the signal recording/reproducing device 353 and the memory 355 through the bus 357, and controls the entire information recording/reproducing apparatus 300 by giving an instruction to each controlling device. In general, software for operating the CPU 354 is stored in the memory 355.

The data input/output control device 306 controls the input/output of the data from the exterior with respect to the information recording/reproducing apparatus 300, to thereby perform storage to and export from the buffer on the memory 355.

The operation control device 307 receives an operation instruction and performs display with respect to the information recording/reproducing apparatus 300, and transmits an instruction by the operation button 310, such as an instruction to record or reproduce, to the CPU 354, and outputs the operation state of the information recording/reproducing apparatus 300, such as during recording and during reproduction, to the display panel 311, such as a fluorescent tube and a liquid crystal panel.

The external network 400 may adopt any of wired and wireless forms, and one portion thereof may be wired and another portion thereof may be wireless. Moreover, it may be a leased line, a public line, a phone line, a packet network, a line switching network, or the like. Moreover, the Internet may be adopted as the external network 400. In any forms, the network line capable of transmitting and receiving the data between the information recording apparatus 300 and the information distributing apparatus 200 may be adopted as the external network 400 in the embodiment.

(2) Explanation of Operation

Next, with reference to FIG. 4, an explanation will be given for the operation principle of the information recording/reproducing apparatus and the information distributing apparatus in the embodiment. FIG. 4 is a flowchart conceptually showing a flow of respective operations of the information recording/reproducing apparatus and the information distributing apparatus in the embodiment.

As shown in FIG. 4, the optical disc 100 to record thereon the content is loaded (inserted) on the information recording/apparatus 300, to thereby perform an initial operation. Specifically, for example, it is checked whether or not the optical disc 100 is an optical disc for content distribution (i.e. for recording the distributed content) (step S101). If it is not the optical disc for content distribution, the loaded optical disc may be ejected, and an instruction to insert the optical disc for content distribution may be outputted.

In addition, as the initial operation, for example, OPC (Optimum Power Calibration) may be performed to adjust the output power of laser light LB for recording, or strategy may be read to adjust the waveform of the laser light LB for recording, or the like.

Moreover, if the loaded optical disc 100 is an optical disc which is already recorded (or on which the content cannot be recorded), the recorded optical disc may be ejected, and an instruction to insert a blank optical disc (or an optical disc on which the content can be recorded) may be outputted.

Then, the NBCA 110 of the loaded optical disc 100 is irradiated with the laser light LB, to thereby read the media ID (step S102). Then, the read media ID is transmitted from the information recording/reproducing apparatus 300 to the information distributing apparatus 200 through the data input/output control device 306, the external network 400, and the external interface 205 (step S103).

At this time, the media ID may be also further encrypted in accordance with a SSL (Secure Socket Layer) or the like, for example, and outputted to the information distributing apparatus 200. Moreover, various information necessary for the content distribution (e.g. a credit card number for charging a content distribution fee, a title of the content which is desired to be distributed, etc.) may be transmitted together with identification information.

Then, the information distributing apparatus 200 receives the media ID (step S104). At this time, for example, if the credit card number is transmitted by the information recording/reproducing apparatus 300, it is preferable to authenticate the credit card number (i.e. get approval from a credit card company). As a result, if, the authentication of the credit card number is completed, the operation explained below is preferably performed. Incidentally, a payment process may be actually performed at this point, or the payment process may be performed after receiving whether or not the recording of the encrypted content is succeeded, as described later.

Then, the information distributing apparatus 200 obtains the disk key, by the operation of the disk key obtaining unit 201 (step S105). Specifically, it obtains the disk key corresponding to the received media ID. At this time, the disk key obtaining unit 201 obtains the disk key by using the disk key table or the like stored in the disk key memory 202.

Now, a more detailed explanation will be given for the disk key table or the like stored in the disk key memory 202, with reference to FIG. 5. FIG. 5 show specific examples of the disk key table indicating a correspondence relationship between the media ID and the disk key of the optical disc 100, stored in the disk key memory 202.

As shown in FIG. 5(a), it may be a disk key table on which an association between one media ID and its corresponding disk key is described. For example, if a media ID of “aaaaaaaa” is transmitted from the information recording/reproducing apparatus 300, the disk key obtaining unit 201 obtains a disk key #1 as the corresponding disk key. Alternatively, if a media ID of “bbbbbbbb” is transmitted, the disk key obtaining unit 201 obtains a disk key #2 as the corresponding disk key.

Incidentally, the media ID is individually allocated to all the optical disks manufactured in the world. On the other hand, since the disk key has a size of about 40 bits, for example, the number of disk keys is less than that of the media IDs. Thus, in some cases, the same disk key is associated with the different media IDs.

Moreover, as shown in FIG. 5(b), it may be a disk key table on which an association between a series of media IDs in a predetermined range and its corresponding disk key is described. For example, if a media ID of “13423234” is transmitted from the information recording/reproducing apparatus 300, the disk key obtaining unit 201 obtains a disk key #1 as the corresponding disk key. Alternatively, if a media ID of “29999983” is transmitted, the disk key obtaining unit 201 obtains a disk key #2 as the corresponding disk key.

Alternatively, the series of media IDs does not necessarily correspond to one disk key, so that it may be a disk key table on which an association between a group of a plurality of media IDs and one disk key corresponding to the group of the plurality of media IDs is described.

It is necessary to prepare such a table in advance, on the basis of the media ID and the type of the disk key recorded on the optical disc having the media ID, along with the manufacturing of the optical disc 100.

Of course, it may be another table other than the above-mentioned tables. In short, it is only necessary for the disk key obtaining unit 201 to recognize the association between N media IDs (wherein N is an integer of 1 or more) and M disk keys (wherein M is an integer of 1 or more). However, the disk key table needs to be severely managed so that a third party cannot easily browse it. Since the disk key table is severely managed as described above, it is possible to increase the confidentiality in the content distribution.

Moreover, it is not limited to the disk key table shown in FIGS. 5, but the disk key may be obtained by using a function in which the input is the media ID and the output is the disk key, for example. This function may be a linear function or a non-linear function, depending on the association between the media ID and the disk key, for example. However, it is preferably a function in which the disk key cannot be easily estimated (i.e. the output cannot be easily estimated from the input).

In FIG. 4 again, the information distributing apparatus 200 encrypts the content outputted from the content data source 204, by using the disk key obtained in the step S105, by the operation of the encrypting unit 203 (step S106). At this time, from the content data source 204, the content desired by a user of the information recording/reproducing apparatus 300 is outputted, on the basis of a title or the like which is transmitted from the information recording/reproducing apparatus 300, for example.

Now, the encryption of the content will be explained in more detail, with reference to FIG. 6 and FIG. 7. FIG. 6 is a flowchart conceptually showing a flow of the operation related to the encryption of content. FIG. 7 is a data structure diagram conceptually showing the data structure of the encrypted content.

As shown in FIG. 6, the encrypting unit 203 firstly obtains a title key (step S201). The title key can be arbitrarily set in accordance with the standard, by a right holder of the copyright (or a distributor, etc.) of the content which is expected to be recorded (i.e. which is expected to be distributed). Therefore, the encrypting unit 203 obtains the set title key. Alternatively, if the title key is set on the information distributing apparatus 200 side, the encrypting unit 203 obtains the title key by setting the title key in accordance with the standard.

Then, by the operation of the encrypting unit 203, the content is encrypted by using the title key obtained in the step S201 (step S202). Moreover, by using the title key, the title key used for the encryption of the content is encrypted (step S203). Incidentally, the disk key is not directly used for the encryption of the content themselves, but used for the encryption of the title key which is used for the encryption of the content. Thus, it can be said that the disk key is a key used for the encryption of the content, practically.

At this time, the encrypted content actually prepared (i.e. content which is encrypted and one specific example of the “encrypted record information” of the present invention) includes the encrypted title key in a sync block (i.e. a header portion) of a sync frame, and include the encrypted content in a main body portion (i.e. a payload portion) of the sync frame, as shown in FIG. 7. Alternatively, the title key may be also recorded in the header portion of a sector, which is provided with a plurality of sync frames. The encrypted content having such a sync frame structure is generated in the encryption process, and recorded onto the optical disc 100 by the information recording/reproducing apparatus 300, as explained below.

In FIG. 4 again, the information distributing apparatus 200 distributes the encrypted content encrypted in the step S106, to the information recording/reproducing apparatus 300, through the external interface 205, the external network 400, and the data input/output control device 306 (step S107). At this time, it may also distribute the encrypted content after further encrypting them in accordance with the standard, such as the SSL.

Incidentally, if the encrypted content is not properly recorded on the optical disc 100, the encrypted content cannot be decoded by using the disk key. Thus, in the distribution of the encrypted content, the attribute of the encrypted content (i.e. CCI (Copy Control Information)) may be set to a “Never Copy” attribute. Namely, even if the encrypted content is recorded once on a hard disk or the like before recorded onto the optical disc 100, the disk key cannot be obtained from the hard disk, so that the encrypted content cannot be reproduced. Thus, even if it is set to the “Never Copy” attribute to distribute the content, that does not cause any problem.

Moreover, in the encryption process in the step S106, a file system or the like is preferably generated at the same time, to thereby make image data including the file system and the encrypted content or the like, and then distribute it to the information recording/reproducing apparatus 300, together with or separately from sector header information.

Then, the information recording/reproducing apparatus 300 receives the distributed encrypted content (or the image data) (step S108), and records it onto the optical disc 100 (step S109). At this time, if the image data and the sector header are distributed, the information recording/reproducing apparatus 300 can record the received data onto the optical disc 100 only by performing modulation according to a DVD format or 8-16 modulation or the like. Moreover, if the distributed encrypted content is encrypted by the SSL or the like, the information recording/reproducing apparatus 300 records it onto the optical disc 100 after decoding it. If the transmitted data is RAW data which is DVD modulated in addition to sync sector data, (i.e. which is obtained after appending ECC, interleaving it, scrambling it, and performing 8-16 modulation on it), then, the data can be recorded as it is onto the optical disc 100.

More specifically, the recording of the encrypted content or the like is started from the address of the last recording area of the lead-in area 104 which is not pre-recorded, and it is ended at the address of the recording area of the lead-out area 108 which is pre-recorded. If the recording of the encrypted content and file system is not performed up to the address of the recording area of the lead-out area 108 which is pre-recorded, buffer data may be recorded up to this address.

Then, it is judged by the operation of the CPU 354 whether or not the recording of the encrypted content is normally ended (step S110). Specifically, it is judged whether or not the recording is normally ended, by judging whether or not all the encrypted content is preferably recorded onto the optical disc 100, or whether or not one portion of the encrypted content cannot be received, or the like. If all the encrypted content is preferably recorded onto the optical disc 100, it may be judged that the recording is normally ended. If at least one portion of the encrypted content is not recorded onto the optical disc 100, it may be judged that the recording is not normally ended.

As a result of the judgment, if it is judged that the recording of the encrypted content is normally ended (the step S110: Yes), result information indicating that is transmitted to the information distributing apparatus 200, by the operation of the data input / output device 306, which is one specific example of the “result information transmitting device” of the present invention, under the control of the CPU 354 (step S114), and the recording operation is ended. On the information distributing apparatus 200 side which receives the result information indicating the normal ending, the credit card payment process may be performed, and a user may be actually charged.

On the other hand, if it is judged that the recording of the encrypted content is not normally ended (the step S110: No), result information indicating that is transmitted to the information distributing apparatus 200, by the operation of the data input/output device 306, (step S111). At the same time, if one portion of the encrypted content is recorded on the optical disc 100, the one portion of the encrypted content may be destroyed by overwriting the UDF portion (for example, the file system or the like). Alternatively, the one portion of the encrypted content may be destroyed by overwriting the one portion of the encrypted content itself. Alternatively, the file system may be not recorded until it is recognized that the recording of the encrypted content is normally ended. In other words, an unusable condition is made so as not to read the one portion of the encrypted content. By this, it is possible to prevent such a disadvantage that the content is used although the recording is not normally ended, and it is possible to preferably protect the copyright of the content.

Moreover, even on the information distributing apparatus 200 side which receives the result information indicating the abnormal ending, a response process in the recording failure is performed (step S113). For example, if the credit card payment process is already performed, a process of paying back the charged amount may be performed, or the encrypted content may be distributed again.

As explained above, by virtue of the content distribution system provided with the information distributing apparatus 200 and the information recording/reproducing apparatus 300, it is possible to properly encrypt the content, distribute the encrypted content, and record it onto the optical disc 100. Particularly in the embodiment, not the disk key (i.e. information which requires high confidentiality) but the media ID of the optical disc 100 (i.e. information which does not require high confidentiality that much) is transmitted from the information recording/reproducing apparatus 300 to the information distributing apparatus 200. At this time, even if the transmitted media ID is browsed by a malicious third party, the media ID is originally open information, so that the third party cannot recognize the encryption method (e.g. the disk key, etc.) by using the media ID. Therefore, even if the encrypted content is browsed by the malicious third party at the distribution stage, the third party cannot decode the encrypted content. If not the medial ID but the disk key, which itself indicates the encryption method, is directly transmitted from the information recording/reproducing apparatus 300 to the information distributing apparatus 200, there is a possibility that the malicious third party obtains the disk key. As a result, there is also considered such a disadvantage that the illegally obtained encrypted content is decoded. However, in the embodiment, the media ID is transmitted as described above, such a disadvantage can be preferably prevented. Therefore, there is such a great advantage that it is possible to effectively prevent the illegal obtainment, copy or duplication, and reproduction or the like of the content, to thereby greatly improve (or increase) the confidentiality in the content distribution. In other words, it is possible to distribute the content under a secure environment. Moreover, since the confidentiality in the content distribution can be increased, it is possible to properly protect the copyright of the content.

Incidentally, the flowchart shown in FIG. 4 mixes and shows the operations of the information distributing apparatus 200 and the information recording/reproducing apparatus 300. The step S101 to the step 103, the step S108 to the step 112, and the step S114 are mainly the operation of the information recording/reproducing apparatus 300. The step S104 to the step 107, and the step S113 are mainly the operation of the information distributing apparatus 200.

Next, with reference to FIG. 8, an explanation will be given for a reproduction operation of reproducing the encrypted content recorded on the optical disc 100, performed by the information recording/reproducing apparatus 300. FIG. 8 is a flowchart conceptually showing a flow of the reproduction operation of reproducing the encrypted content by the information recording/reproducing apparatus in the embodiment.

Firstly, as the premise of the reproduction operation, the optical disc 100 is loaded on the information recording/reproducing apparatus 300, and various initial operations are performed. As the various initial operations, the check of the media ID, the check of whether the optical disc 100 is recording media or the like (e.g. whether there is the wobble, etc.), the check of whether or not it is a multilayer type optical disc, the check of whether it adopts a parallel track path or an opposite track path in the case of the multilayer type optical disc, the check of whether or not the recorded content is encrypted, the check of whether or not it is an optical disc on which the reproduction can be properly performed (i.e. the check of whether or not it is the illegal disc), and the like are performed. As a result of the initial operations, if it is judged to be the optical disc on which the reproduction cannot be properly performed, an indication of the fact may be displayed on a display or the like, and the optical disc may be ejected.

Incidentally, here, the following explanation will be continued under the assumption that the content recorded in the data recording area 106 is encrypted.

As shown in FIG. 8, firstly, the disk key is obtained (step S301). Specifically, the disk key recorded in the control data zone 120 on the optical disc 100 is read. Then, the file system is obtained (step S302).

Then, the title key is decoded by using the disk key obtained in the step S301 (step S303). Then, the encrypted content is decoded by using the title key decoded in the step S303 (step S304). By this, it is possible to preferably reproduce the decoded content (i.e. video images and audio or the like indicating the original content) (step S305). After that, it is judged whether or not the reproduction is ended (step S306), and if the reproduction is ended, the reproduction operation may be ended, and the optical disc 100 may be ejected.

Incidentally, in the above-mentioned embodiments, the explanation is made by using the encryption system described in the non-patent document 1 as the encryption method; however, of course, another encryption method can adopt the same construction. In short, the information directly used for the encryption, such as the disk key, is not directly exchanged between the information recording/reproducing apparatus and the information distributing apparatus. If the information which can specify the encryption key yet which itself is open information is directly exchanged between the information recording/reproducing apparatus and the information distributing apparatus, it is possible to receive the above-mentioned various benefits.

Moreover, in the above-mentioned embodiments, the disc 100 is explained as one specific example of the information recording medium, and the recorder (player) related to the optical disc 100 is explained as one example of the information recording apparatus. The present invention, however, is not limited to the optical disc and the recorder (player) thereof, and it can be also applied to other various recording media and the recorder (player) thereof.

The present invention is not limited to the above-described embodiments, and various changes may be made, if desired, without departing from the essence or spirit of the invention which can be read from the claims and the entire specification. An information recording medium, an information recording apparatus, an information recording method, an information distributing apparatus, an information distributing method, and a computer program for recording control and for distribution control, which involve such changes, are also intended to be within the technical scope of the present invention.

### INDUSTRIAL APPLICABILITY

The information recording medium, the information recording apparatus and method, the information distributing apparatus and method, and the computer program of the present invention can be applied to an information recording medium, such as a DVD, and information recording apparatus and an information recording method, such as a DVD recorder, and an information distributing apparatus for and an information distributing method of distributing content to the information recording apparatus or the like. Moreover, they can be applied to an information recording apparatus, an information distributing apparatus or the like, which is mounted on or can be connected to various computer equipment for consumer use or business use, for example.

1-17. (canceled)

18. An information recording medium provided with:
an identification information recording area in which identification information for identifying an information recording medium is recorded in advance;
an encryption key recording area in which an encryption key for encrypting record information is recorded in advance, the encryption key corresponding to the identification information in a relationship of N versus M (wherein each of N and M is an integer of 1 or more); and
an encrypted record information recording area to record therein encrypted record information which is encrypted on the basis of the encryption key.

19. The information recording medium according to claim 18, wherein the encryption key is used for encrypting an another encryption key which is used for encrypting the record information, and the another encryption key is recorded into the encrypted record information recording area as well as the record information.

20. An information recording apparatus for recording the encrypted record information onto an information recording medium provided with: an identification information recording area in which identification information for identifying an information recording medium is recorded in advance; an encryption key recording area in which an encryption key for encrypting record information is recorded in advance, the encryption key corresponding to the identification information in a relationship of N versus M (wherein each of N and M is an integer of 1 or more); and an encrypted record information recording area to record therein encrypted record information which is encrypted on the basis of the encryption key said information recording apparatus provided with:
an identification information transmitting device for transmitting the identification information which is recorded on the information recording medium, to an information distributing apparatus for distributing the encrypted record information;
an encrypted record information receiving device for receiving the encrypted record information, which is distributed from the information distributing apparatus and is encrypted on the basis of the encryption key corresponding to the identification information; and
a recording device for recording the received encrypted record information.

21. An information recording method of recording the encrypted record information onto an information recording medium provided with: an identification information recording area in which identification information for identifying an information recording medium is recorded in advance; an encryption key recording area in which an encryption key for encrypting record information is recorded in advance, the encryption key corresponding to the identification information in a relationship of N versus M (wherein each of N and M is an integer of 1 or more); and an encrypted record information recording area to record therein encrypted record information which is encrypted on the basis of the encryption key said information recording method provided with:
an identification information transmitting process of transmitting the identification information which is recorded on the information recording medium, to an information distributing apparatus for distributing the encrypted record information;
an encrypted record information receiving process of receiving the encrypted record information, which is distributed from the information distributing apparatus and is encrypted on the basis of the encryption key corresponding to the identification information; and
a recording process of recording the received encrypted record information.

22. An information distributing apparatus for distributing the encrypted record information to an information recording apparatus for recording the encrypted record information onto an information recording medium provided with: an identification information recording area in which identification information for identifying an information recording medium is recorded in advance; an encryption key recording area in which an encryption key for encrypting record information is recorded in advance, the encryption key corresponding to the identification information in a relationship of N versus M (wherein each of N and M is an integer of 1 or more); and an encrypted record information recording area to record therein encrypted record information which is encrypted on the basis of the encryption key, said information recording apparatus provided with: an identification information transmitting device for transmitting the identification information which is recorded on the information recording medium, to an information distributing apparatus for distributing the encrypted record information; an encrypted record information receiving device for receiving the encrypted record information, which is distributed from the information distributing apparatus and is encrypted on the basis of the encryption key corresponding to the identification information;
and a recording device for recording the received-encrypted record information, said information distributing apparatus comprising:
an identification information receiving device for receiving the identification information which is transmitted from the information recording apparatus;
an encryption key obtaining device for obtaining the encryption key corresponding to the received identification information;
an encrypting device for encrypting the record information on the basis of the obtained encryption key, to thereby generate the encrypted record information; and
a distributing device for distributing the generated encrypted record information to the information recording apparatus.

23. The information distributing apparatus according to claim 22, wherein said encryption key obtaining device obtains the encryption key on the basis of at least one of a correspondence table and a function for defining an association between the identification information and the encryption key.

24. The information distributing apparatus according to claim 22, wherein an attribute of the distributed encrypted record information is a “Never Copy” attribute.

25. The information distributing apparatus according to claim 22, wherein said encrypting device encrypts the record information by using a predetermined title key and encrypts the title key by using the encryption key, to thereby generate the encrypted record information.

26. An information distributing method of distributing the encrypted record information to an information recording apparatus for recording the encrypted record information onto an information recording medium provided with: an identification information recording area in which identification information for identifying an information recording medium is recorded in advance; an encryption key recording area in which an encryption key for encrypting record information is recorded in advance, the encryption key corresponding to the identification information in a relationship of N versus M (wherein each of N and M is an integer of 1 or more); and an encrypted record information recording area to record therein encrypted record information which is encrypted on the basis of the encryption key, said information recording apparatus provided with: an identification information transmitting device for transmitting the identification information which is recorded on the information recording medium, to an information distributing apparatus for distributing the encrypted record information; an encrypted record information receiving device for receiving the encrypted record information, which is distributed from the information distributing apparatus and is encrypted on the basis of the encryption key corresponding to the identification information;
and a recording device for recording the received encrypted record information, said information distributing method comprising:
an identification information receiving process of receiving the identification information which is transmitted from the information recording apparatus;
an encryption key obtaining process of obtaining the encryption key corresponding to the received identification information;
an encrypting process of encrypting the record information on the basis of the obtained encryption key, to thereby generate the encrypted record information; and
a distributing process of distributing the generated encrypted record information to the information recording apparatus.

27. A computer program product in a computer-readable medium for tangibly embodying a program of instructions executable by a computer provided in an information recording apparatus, to make the computer function as at least one portion of an identification information transmitting device, an encrypted record information receiving device, and a recording device,
said information recording apparatus for recording the encrypted record information onto an information recording medium provided with: an identification information recording area in which identification information for identifying an information recording medium is recorded in advance; an encryption key recording area in which an encryption key for encrypting record information is recorded in advance, the encryption key corresponding to the identification information in a relationship of N versus M (wherein each of N and M is an integer of 1 or more); and an encrypted record information recording area to record therein encrypted record information which is encrypted on the basis of the encryption key, said information recording apparatus provided with:
said identification information transmitting device for transmitting the identification information which is recorded on the information recording medium, to an information distributing apparatus for distributing the encrypted record information;
said encrypted record information receiving device for receiving the encrypted record information, which is distributed from the information distributing apparatus and is encrypted on the basis of the encryption key corresponding to the identification information; and
said recording device for recording the received encrypted record information.

28. A computer program product in a computer-readable medium for tangibly embodying a program of instructions executable by a computer provided in an information distributing apparatus, to make the computer function as at least one portion of an identification information receiving device, an encryption key obtaining device, an encrypting device, and a distributing device,
said information distributing apparatus for distributing the encrypted record information to an information recording apparatus for recording the encrypted record information onto an information recording medium provided with: an identification information recording area in which identification information for identifying an information recording medium is recorded in advance; an encryption key recording area in which an encryption key for encrypting record information is recorded in advance, the encryption key corresponding to the identification information in a relationship of N versus M (wherein each of N and M is an integer of 1 or more); and an encrypted record information recording area to record therein encrypted record information which is encrypted on the basis of the encryption key, said information recording apparatus provided with: an identification information transmitting device for transmitting the identification information which is recorded on the information recording medium, to an information distributing apparatus for distributing the encrypted record information; an encrypted record information receiving device for receiving the encrypted record information, which is distributed from the information distributing apparatus and is encrypted on the basis of the encryption key corresponding to the identification information;
and a recording device for recording the received encrypted record information, said information distributing apparatus comprising:
said identification information receiving device for receiving the identification information which is transmitted from the information recording apparatus;
said encryption key obtaining device for obtaining the encryption key corresponding to the received identification information;
said encrypting device for encrypting the record information on the basis of the obtained encryption key, to thereby generate the encrypted record information; and
said distributing device for distributing the generated encrypted record information to the information recording apparatus.
